(19) United States
(12) Patent Application Publication
(10) Pub. No.: US 2019/0113014 A1
(43) Pub. Date: Apr. 18, 2019

(54) AUTOMATIC GENERATOR START SYSTEM FOR A PORTABLE GENERATOR HAVING ELECTRIC START

(71) Applicant: Aldelano IP Holdings, LLC, Ontario, CA (US)

(72) Inventors: Alfred Hollingsworth, Ontario, CA (US); Nicole Smith, Grand Rapids, MI (US); Michael Goodwyn, Jackson, TN (US); Nicholos Rakestraw, Jackson, TN (US)

(21) Appl. No.: 16/090,511

(22) PCT Filed: Apr. 3, 2017
(86) PCT No.: PCT/US2017/025716

§ 371 Date: Oct. 1, 2018

Related U.S. Application Data
(60) Provisional application No. 62/317,141, filed on Apr. 1, 2016.

(51) Int. Cl. F02N 11/08; F02D 29/06; F02D 41/02; F02B 63/04

(52) U.S. Cl. CPC F02N 11/0825; F02D 29/06; F02N 2200/063; F02B 63/04; F02N 11/0862; F02D 41/021

(57) ABSTRACT

An automatic generator start (AGS) system that includes a battery and a controller for monitoring a voltage. A relay system is then used that is comprised of a plurality of relays that are individually actuated by the controller. An ignition for a gasoline powered generator can then be fully controlled so that the controller monitors the voltage of the battery and actuates the relay system for starting or stopping the gasoline powered generator ignition when the voltage is at some predetermined value.

### FIELD OF THE INVENTION

The present invention relates generally to portable generators and more particularly to an auto-start electrical system for a portable generator used in connection with a solar power cold box refrigeration system.

### BACKGROUND

Portable refrigeration systems often demand a power source to supplement a renewable energy system such as solar power. Engine-driven electrical power generators can provide a viable technological solution. The internal combustion engine is a mature technology that has been employed with great success the world over. The advantages of the engine-driven generator are many, and in refrigeration applications, it can be a short-term solution when renewable energy system is incapable of providing adequate power to keep the system running.

The term portable generator is very broad and includes both internal and external combustion type engines including micro-turbines. A piston-type internal combustion engine refers to any engine utilizing the combustion of a fuel to push a piston within a cylinder. This reciprocal motion is changed into a more useful rotary motion by the crankshaft. There are a wide range of engine-driven generators available, from portable units capable of supplying a few hundred watts of power to enormous, multi-megawatt units capable of supplying grid power for a small city. The demand for autonomous power supplies has fueled tremendous competition among manufacturers of generators. This has led to advances in the technology and generally lower prices, particularly in the portable generator market.

One of the issues associated with smaller type generators is that they do not automatically start and stop and must be manually started by the operator when an engine powered inverter is required. Even if automatic start is a desired feature, it often is not available from the manufacturer in many types of portable power generators cannot be separately added by the consumer.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating a portable generator in accordance with some embodiments of the invention.

FIG. 2 is a block diagram of the automatic generator start (AGS) system in accordance with an embodiment of the invention.

FIG. 3 is block diagram illustrating the water generation system according to various embodiments of the invention.

FIG. 4 is a block diagram of the water filtration system as used with the water generator illustrated in FIG. 3.

FIG. 5 is a flow chart diagram illustrating the steps used in repurposing a shipping container into a solar powered refrigerated cold box.

FIG. 6 illustrates a shipping container after repurposing for use as a refrigerated cold box powered using off-grid power applications.

FIG. 7 is an illustration of a c-channel structural member used in accordance with embodiments of the invention.

FIG. 8 is a block diagram illustrating a solar powered charging system using space efficient battery bank according to an embodiment of the invention.

FIG. 9 is a diagram illustrating the space efficient orientation of individual cells in the battery bank.

FIG. 10 is an alternative embodiment illustrating another space efficient orientation of individual cell in a battery bank.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an automatic generator start (AGS) system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an automatic generator start (AGS) system described herein. The non-processor circuits may include, but are not limited to, a radio receiver, a radio transmitter, signal drivers, clock circuits, power source circuits, and user input devices. As such, these functions may be interpreted as steps of a method to perform automatic starting of a portable generator. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

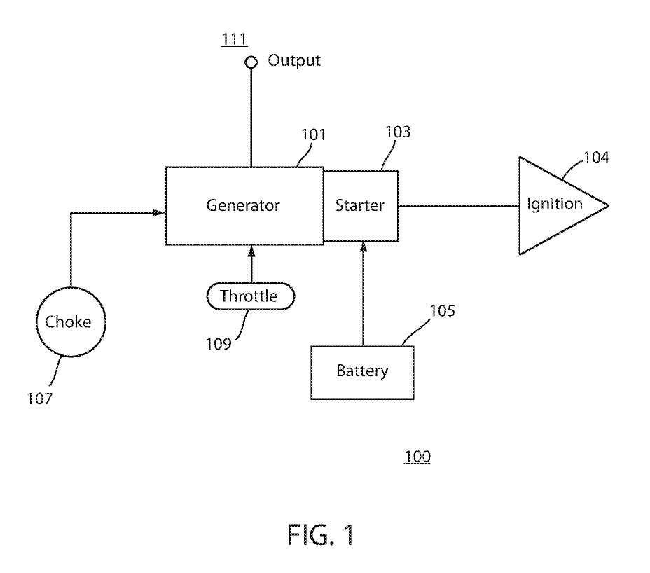

FIG. 1 is block diagram illustrating a portable generator in accordance with some embodiments of the invention. A portable generator 100 includes the generator motor 101 which is connected to an electric starter motor 103. The electric motor controlled using an ignition 104 and powered by a battery 105. During startup, a choke 107 is used to adjust the air/fuel ratio and a throttle control 109 is used to control engine speed. Once started, an AC voltage (typically 120 volts) is provided at output 111. This voltage can be used to operate a refrigeration system as well as recharge batteries used to power AC inverters or the like. The resultant AC voltage can be used to power refrigeration equipment or other devices.

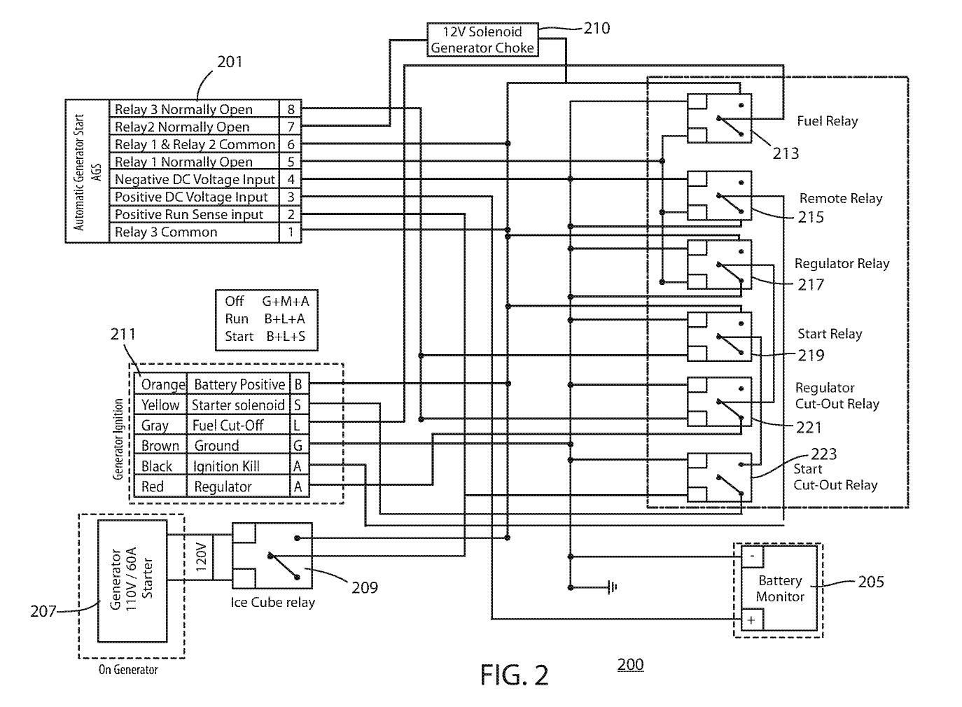

FIG. 2 is a block diagram of the automatic generator start (AGS) system in accordance with an embodiment of the invention. The AGS system 200 includes a AGS controller 201 that is used to provide voltages for actuating a group of relays in a relay system 203. The AGS controller has eight terminals or ports to either to generate a voltage to key a relay or to measure a voltage against some predetermined value. As seen in the AGS legend, these ports include 1) a relay No. 3 common, 2) positive run sense input; 3) positive DC voltage input; 4) negative DC voltage input; 5) relay No. 1 normally open; 6) relay No. 1 and relay No. 2 Common; 7) relay 2 normally open; and 8) relay No. 3 normally open. The relay number, for example relay No. 1, refers to the electrical relays used in the relay system 203 as described herein.

As seen in the block diagram, the AGS controller can provide various control voltages to relay system 203. The relay system 203 is comprised of six relays that include but are not limited to a fuel relay 213, remote relay 215, regulator relay 217, start relay 219, regulator cut out relay 221 and start-cut out relay 223. The relays in the relay system 203 work to control interaction of various control systems on the generator ignition 211. The generator ignition 211 includes at least six inputs or ports that are used to control generator operation such as startup and shut-down. These ports include battery positive (B), starter solenoid (S), fuel cut-off (L), ground (G), ignition kill (M) and regulator (A). By controlling this inputs in various combinations, the generator can be started, run and stop by the AGS system 201.

In use, the AGS 201 utilizes a battery monitor 205 to monitor the overall voltage of the series connected battery cells. For example, a total of 24 2-volt cells would be 48 volts. In one application, these cells are charged using solar energy and work to power an AC inverter. When the battery is drained, and reaches some predetermined level, the AGS 201 will auto-start the portable generator. For example, if the bank of batteries is typically 48 volts, when it falls to 40 volts, this low voltage is detected, and the AGS will provide electrical voltages to actuate the relay system 203 to start the portable generator. In order to start a particular function of the generator ignition, various groups of relays are activated to accomplished certain tasks. For example, in order to start the generator, ports BLS are actuated. Once running, the BLA ports are actuated and a 12 volt solenoid is actuated by the AGS 201 in order to adjust the choke settings of the generator's carburetor. In the event, the generator produces more voltage than desired i.e. more than 120 VAC, a circuit breaker 207 and relay 209 are used to by the AGS 201 to shut down the generator ignition using ports GMA. In normal use, when the batteries are recharged, the generator can also be shut down using relays to activate ports GMA on the generator ignition 211.

Thus, the present invention related to an automatic generator start (AGS) system and method of providing automatic start to a portable generator. The AGS system includes a controller and relay system. The controller provides voltages to the relay system for activating various combinations of relays. The relay system is interfaced into the ignition system of the portable generator allowing the AGS to start, run and stop the generator when battery voltages drain and charge to predetermined levels.

In yet another embodiment of the invention, traditional water generation system work to filter and purify tap and well water. Bottled water can be overpriced, cumbersome and difficult to store. A third source of water is from an atmospheric water generator (AWG) AWG are new, state of the art system that takes humidity from the air to produce pure drinking water. The AWG operates by extracting humidity from the air and then converting it into potable drinking water. The AWG is typically a humidity and temperature driven, self-contained unit, making water from air. It can generate gallons of water per day depending on the specific atmospheric conditions. In underdeveloped nations, this technology can help to meet the growing demand for economical, good tasting and quality drinking water. Atmospheric water generation is a green friendly, alternative source, for users who wish to maintain control over their own water supply.

The capacity of the atmospheric water generator relies on the level of humidity in the air which generally must be in excess of 30% and the temperature. The Atmospheric Water Generator water is treated with ozone for clean and pure water production along with multiple filters to ensure every drop stays fresh and clean for human consumption. No longer must persons in remote areas rely on municipal water systems or the transportation and storage of bottled water. Those in need, in any region or the world with adequate humidity, can have constant access to clean drinking water.

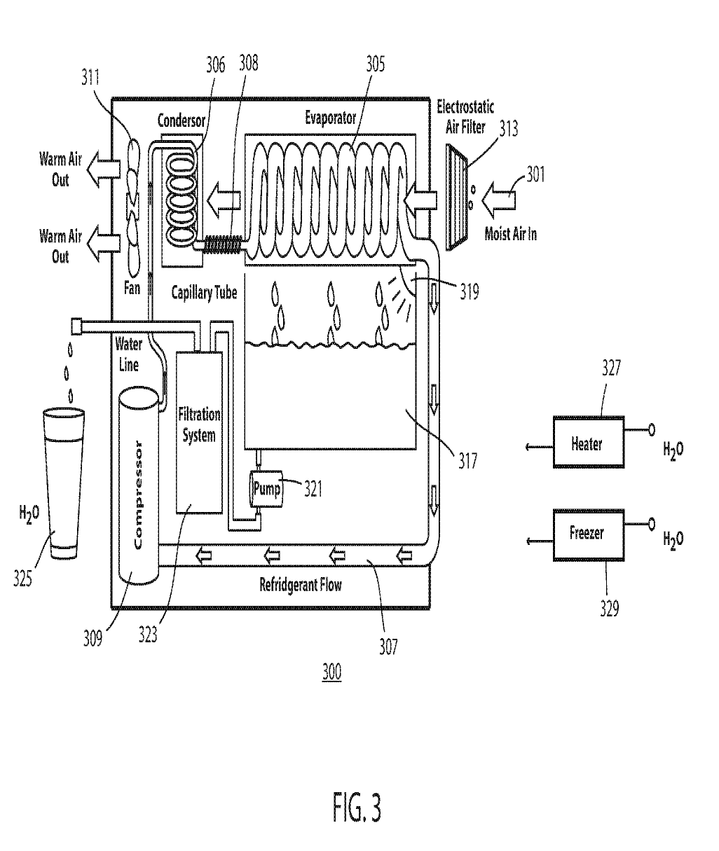

FIG. 3 is block diagram illustrating an atmospheric water generator with heating and ice capability according to an embodiment of the invention. An atmospheric water generator (AWG), is a device that extracts water from moist ambient air. Water vapor in the air is condensed by cooling the air below its dew point, exposing the air to desiccants, or pressurizing the air. Unlike a dehumidifier, an AWG is designed to render the water potable. Because there is almost always a small amount of water in the air that can be extracted, AWGs are useful where safe drinking water is difficult or impossible to obtain. Hence, research has developed AWG technologies to produce useful yields of water at a reduced energy cost.

Many atmospheric water generators operate in a manner very similar to that of a dehumidifier where air is passed over a cooled coil which causes the water to condense. The rate upon which water is produced depends on many factors including the air's ambient temperature, humidity, the volume of air passing over the coil, and the machine's capacity to cool the coil. In operation, these systems typically reduce air temperature, which in turn reduces the air's capacity to carry water vapor. This is the most common technology in use, but when powered by typical electrical systems can demand a lot of energy for water production.

As seen in FIG. 3, a cooling condensation type atmospheric water generator 300 operates in a manner where moist air 301 is filtered 303 through and electrostatic filter or the like. This air is passed over an evaporator 305 and on to a condenser coil 306. The air exits the water generator using a fan 311. Air passing over the evaporator 305 causes condensation that is collected by a holding tank 317. Water falls by gravity from the evaporator 305.

In order to make the water safe to drink, the water in the holding tank 317 is initially cleansed using a first UV light 319. The first UV light is positioned at a predetermined position within the tank so that the ultraviolet light rays can reach the surface of the stored water to kill any bacteria or protozoa. After exposure to UV, the water is pumped using an electric pump 321 from the holding tank 317 to a multi-stage filtration system 323. The multistage filtration system 323 is described in more detail with regard to FIG. 2. After making its way through the multistage filtration system 323, the water 325 is clean and potable where it can be used for drinking or the like.

The process for condensing the water present in the air involves the use of a compressor 309. The compressor 309 is typically electrically powered and circulates refrigerant (such as Freon or the like) in pipe 307 through a condenser 306. The condenser 306 connects with evaporator 305 through a capillary tube 308. It is the evaporator coil 305 that cools the air surrounding it. This lowers the air's temperature to its dew point, causing water in the air to condense. A controlled-speed fan 311 forces filtered air over the evaporator coil 305. As noted above, the resulting potable water is then passed into the holding tank 317 where a purification and filtration system, such at first UV light 319 keep the water clean and free of bacteria. The first UV light 319 reduces the risk posed by viruses and bacteria which may be collected from the ambient air on the evaporator coil by the condensing water.

The rate at which water can be produced depends on relative humidity and ambient air temperature and size of the compressor and evaporator. Atmospheric water generators become more effective as relative humidity and air temperature increase. As a rule of thumb, cooling condensation atmospheric water generators do not work efficiently when the temperature falls below 18.3° C. (65° F.) or the relative humidity drops below 30%. This means they are relatively inefficient when located inside air-conditioned offices. The cost-effectiveness of an AWG depends on the capacity of the machine, local humidity and temperature conditions and the cost to power the unit. Once potable water is produced, the water can be heated using a heating unit 327 or alternatively can be frozen to produce ice using a freezing unit 329. Those skilled in the art will recognize that the process of refrigeration involves a compressor heating the refrigerant to create a hot gas that is sent to the condenser which cools the gas to a liquid. During this process, heat is expelled around the condensing coil that can be captured and used in connection with a heat exchanger. The heat exchanger can then be used to heat the potable water prior to the heat being expelled from the system.

Further, a temperature sensor can be inserted in the condensing coil that will turn the compressor off when the coil temperature gets close to predetermined temperature such as freezing. Variable speed technology can be used to vary the compressor fan speed to maintain the condensing coil at a specific temperature. Optimally, this temperature is slightly above freezing but always below the dew point. This allows the water generator to operate in marginal conditions regardless of the environment. Moreover, the dew point can be calculated allowing the water generation unit to operate only when it is practical, regardless of the climate or geographic location of the refrigeration unit. Further, the refrigeration unit uses software that can “learn” when the most moisture is available in a 24 hour period and maximize its water production during that time period.

In another embodiment, the cool air from the unit's evaporator can move past the condenser such that the air volume through both of these coils can be independently varied using only one blower. This enables more water to be produced at lower power consumption with less stress on the unit's compressor. A highly efficient, variable speed blower motor can be used with software control.

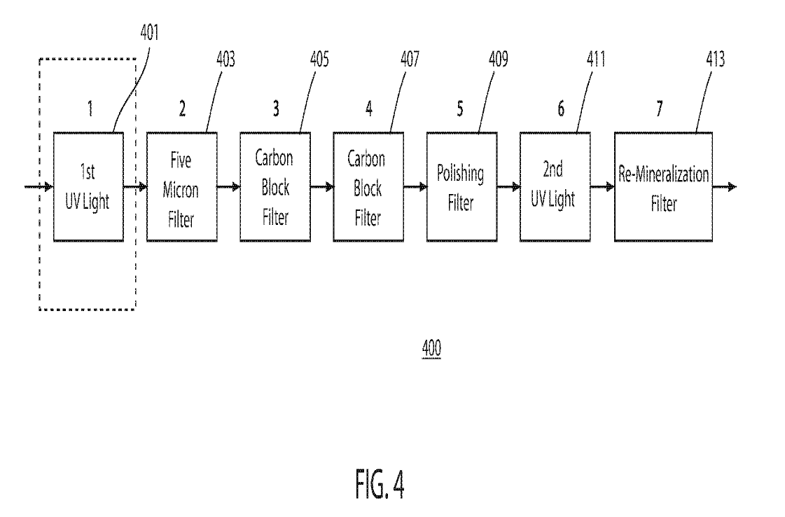

FIG. 4 is a block diagram of a multi-stage water filtration system as used with the water generator illustrated in FIG. 3. The multi-stage water filtration system 400 receives water from a first UV light 401 located within a holding tank as described herein. After being pumped from the holding tank the water is sent though piping to a sediment filter 403. Although many sizes are available, a sediment filter that can strain particles at least 5 micron in size is typically used. The filter is a cartridge type filter that can easily be removed and replaced. Those skilled in the art will recognize that virtually all cartridge-style sediment filters follow a “radial flow” pattern. In a radial flow design, water flows through the wall of the filter into the inner core. This arrangement provides a filtering surface that consists of the entire length and circumference of the cartridge. Filters can be configured as “depth” filters or “pleated” filters although pleated filters offer more filtering surface area. Although water filters can have many purposes, the sediment filter 403 is intended to remove suspended solids, variously referred to as turbidity, sediment or particulate rather than metallic contaminants, “dissolved solids” chemicals and/or charged particles.

After leaving the sediment filter 403, the water is directed though a first carbon block filter 405. The first carbon block filter 405 acts to reduce any chlorine taste and/or odor. Carbon block filters contain pulverized activated carbon that is shaped into blocks under high pressure. The filter is typically more effective than granulated activated carbon filters because it has more surface area. The effectiveness of the first carbon block filter 405 depends in part on the rate upon which water flows through it. Thereafter, the water is directed to a second carbon block filter 407 for added protection and improvement of taste and odor.

After exiting the second carbon block filter 407, water is directed to a granular activated carbon final polishing filter 409. Granulated activated carbon filters contain fine grains of activated carbon. They are typically less effective than carbon block filters because they have a smaller surface area of activated carbon. Its effectiveness in enhancing taste also depends on how quickly water flows though the filter.

Upon exiting the polishing filter 409, water is then directed to a second UV light filter 411. UV light filtration is very effective as it takes approximately 90 seconds to purify 32 fl. oz. of water with most UV purifiers. No wait time is needed before drinking once the water has been exposed to UV light for the appropriate amount of time. A number of factors combine to make UV radiation a superior means of water purification for rainwater harvesting systems. Ultraviolet radiation is capable of inactivating all types of bacteria. Additionally, ultraviolet radiation disinfects rapidly without the use of heat or chemical additives which may undesirably alter the composition of water.

The ultraviolet spectrum includes wavelengths from 2000 to 3900 Angstrom units (Å). One unit is one ten billionth of a meter. The 2000 to 3900 Å range is typically divided into three segments namely:

a) Long-wave ultraviolet—The wavelength range is 3250 to 3900 Å. These rays occur naturally in sunlight and have little germicidal value;
b) Middle-wave ultraviolet—The wavelength range is 2950 to 3250 Å, also found in sunlight and is best known for its sun-tanning effect. It provides some germicidal action, with sufficient exposure; and
c) Short-wave ultraviolet—The wavelength range is 2000 to 2950 Å where this segment possesses by far the greatest germicidal effectiveness of all ultraviolet wavelengths. It is employed extensively to destroy bacteria, virus, mold, spores, etc., both air- and water-borne. Short-wave ultraviolet does not occur naturally at the earth's surfaces, as the earth's atmosphere screens out sunlight radiation below 2950 Å.

In order to take practical advantage of the germ-killing potential of short-wave ultraviolet, it is necessary to produce this form of energy through the conversion of electrical energy. The conversion of electrical energy to short-wave radiant ultraviolet is accomplished in a mercury vapor lamp or UV solid state devices such as light emitting diodes (LEDs). After being cleansed by the second UV light 411, the water may also be sent though a re-mineralization filter 413. The purpose of the re-mineralization filter 413 is to add natural calcium and magnesium minerals to the water giving it a better taste. In other embodiments of the invention, the filter sequence may be: at least one sediment filter, at least one granular activated carbon filter, at least one inline UV light, at least one remineralization filter, at least one reverse osmosis filter and at least one ozonator inside storage tank.

In still other embodiments, the refrigeration system and the water treatment/storage system may be two separate units where the refrigeration portion of the unit is a separate “self-contained” unit. The water generator might be built from lightweight aluminum with handles on both sides so it can be easily transported or moved. It can then be placed on an elevated platform. This would allow the water it produces to gravity flow (without the need for a pump) into a self-contained” holding tank and treatment system at a lower level. This water could then be pumped through a filtration and sterilization system into a holding tank. In still embodiments, the refrigeration and water generation units can vary in capacity so as to match the “available” electrical power stored in batteries, when full power is not available.

Thus, the present invention is directed to a solar powered atmospheric water generation unit utilizing a multi-stage water filtration system. More specifically, the water filtration system includes two UV light devices, a sediment filter, two carbon block filters, a polishing filter and a re-mineralization filter. The use of the multi-filtration system with the AWG insures clean and good tasting potable water at locations were municipal water or well water is not possible.

In yet another embodiment of the invention, refrigerated cold box containers are well known in the art. However, when used in situations where they are remotely powered, they often too inefficient such that power is wasted to maintain freezing temperatures. Energy generated by the sun or stored in batteries needs to be used very efficiently in view of the high duty cycle of the cold box. Hence, the cold box must be as thermally efficient as possible.

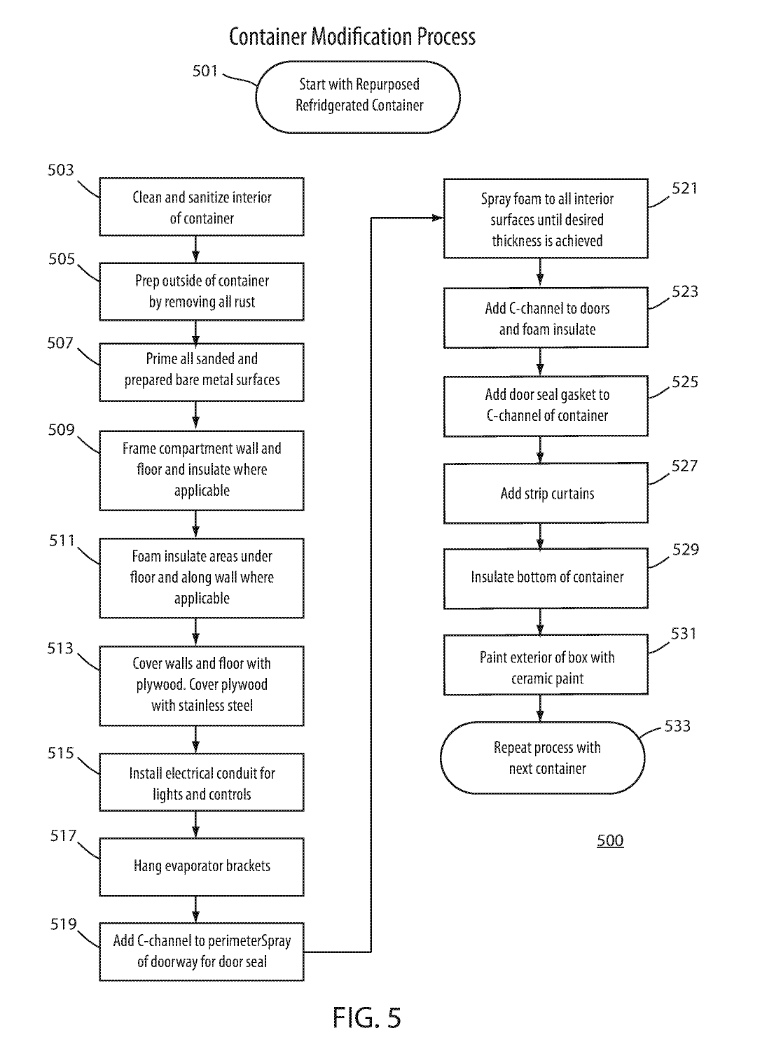

FIG. 5 is a flow chart illustrating steps in a method repurposing a shipping container into a refrigerated cold box. The method 500 starts initially with a repurposed refrigeration container that will be powered “off grid” using solar energy and batteries or portable on-board AC generator. Initially, the interior of the repurposed cold box container is cleaned and sanitized generally using a pressure washer using a chemical additive 503. The outside of the container is also prepared by removing all rust and/or other debris 505. All bare metal surfaces, both inside and outside the container are sanded and primed so as to prevent further rust or corrosion through exposure to moisture 507. Thereafter, the compartment walls can then be framed and insulated where applicable 509. Those skilled in the art will also recognize that internal framing may be accomplished using wood or metallic members. Many different internal framing configurations are possible however the interior of the cold box is generally framed into either two or three sections. Areas under the floor and along the walls are foam insulated to an insulation value of at least R-50 511. The foam may be applied using sheets, rolls, spraying or the like. The walls and floor are next covered in plywood that has been wrapped in stainless steel sheet metal 513. Electrical conduit can then be installed for both the lights and any required control circuitry 515. Evaporator brackets for hanging refrigeration evaporators are then hung on the walls 517 at predetermined locations to accommodate their size and venting requirements.

FIG. 6 illustrates a c-channel 200 that is sometimes referred to as a structural channel. A c-channel is added to the perimeter of the doorway door seal 519. Its cross section consists of a wide “web” 601, that is typically oriented vertically and two “flanges” at the top and bottom of the web 603, 605. The flanges stick out on one side of the web so that the c-channel can lay flat on a floor or wall surface. A c-channel is distinguished from an I-beam, H-beam or W-beam type steel cross section in that those structures have flanges on both sides of the web.

Once the c-channel is installed, foam is then applied to all interior surfaces until a desired thickness and R value is achieved 521. A c-channel is then added to the doors and filled with foam insulation 523. A door seal gasket is added to the c-channel 525. Strip curtains are then added 527 and the interior bottom of the container is insulated 529. The exterior of the box can then be painted with a thermal protective coating such as ceramic paint 531 or the like and this process is repeated with the next container as necessary 533.

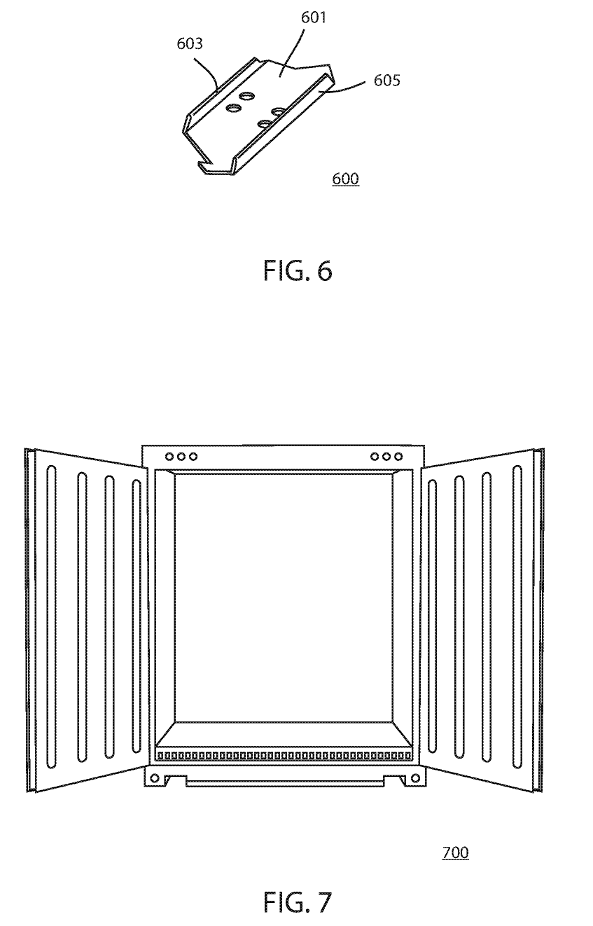

FIG. 7 is an illustration showing a shipping container that has been repurposed into a cold box. A typical cold box 700 may include some minimal insulation which can range from as little as ½ inch in thickness for vegetable produce haulers up to 6 inches in thickness for ice cream carriers. Many cold box containers used for local and regional food-service deliveries have approximately 2.5 inches of wall insulation. These can operate with two cold compartments and a third non-cooled compartment for dry groceries. The three compartments can be separated by movable insulated bulkheads. Food-service type trailers are usually built more stoutly than long-haul reefers since customers want strength and durability in every component of the box so it will last typically from 10 to 20 years. In the trucking industry, long-haulers want light weight to carry higher payloads, so they specify things like aluminum structural members and thinner walls. Such trailers wear out faster, but planned life cycles are correspondingly short.

Generally, the amount of insulation needed in the cold box is determined by the temperature of refrigeration required. Other important factors include the airflow which must flow around the refrigerated contents within the box. To achieve airflow, air chutes is generally recommended, especially in longer trailers or in circumstances where constant temperature is desired throughout the cold box. When repurposing the cold box for use in solar powered application, those skilled in the art will recognize that insulation must be adequate on each of the walls, ceiling, floors and doors. The heat transport constant, referred to as “Ua value”, is a measure of the trailer's thermal efficiency where the higher the Ua number, the more refrigeration will be required.

Over time, insulation will degrade, crumble and absorb moisture, etc. This allows heat and cold will move more easily from outside and inside the trailer. Hence, when repurposing a cold box, it is wise to specify some additional reserve capacity allowing for this degradation. Moreover, the outer body color of the cold box can affect internal temperature such that the darker cold box surface, the more of the sun's heat will be absorbed and the more cooling capacity will be required to maintain temperature in warmer climates. Swing doors generally seal more completely than roll-up doors. Side doors can add delivery convenience, but introduce more openings through which cooled air will be lost. The cold box flooring typically will include channels that promote airflow underneath the cargo, as opposed to a flat or “diamond plate” type floor. Finally, a corrugated metal skin can be placed on the outside surface of the box.

In still yet another embodiment of the invention, a solar-powered refrigerator is a refrigerator that runs on energy directly provided by sun, and may include photovoltaic or solar thermal energy. Solar-powered refrigerators are able to keep perishable goods such as meat and dairy cool in hot climates, and are used to keep much needed vaccines at their appropriate temperature to avoid spoilage. Solar-powered refrigerators may be most commonly used in the developing world to help mitigate poverty and climate change.

In developing a solar-powered refrigerator, it is important to utilize space for control system, electronics, generators and batteries as efficiently as possible since most of the space of the container is generally needed for refrigeration.

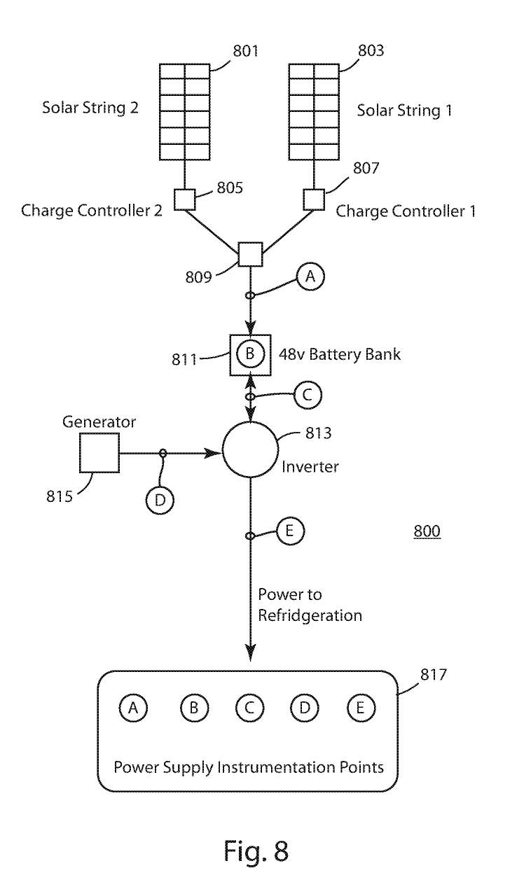

FIG. 8 illustrates a block diagram of a power supply system 800 for the refrigerated cold box. The cold box consists of the following components. a) 24 solar panels 801, 803 each are typically rated at approximately 315 watts peak power and are output arranged in two strings of twelve panels. Hence, the rated output of solar array is approximately over 7.5 KW. The design point for solar insulation is typically six hours of rated output per day as an annual average. On an annual basis this power supply will produce over 45 KW-hr/day of operation.

Each string of solar panels 801, 803 charge a battery bank 811 through a respective charge controller 805, 807. For example, a charge controller made by Maximum Power Point Technology (MPPT) can be used for such a purpose. These devices ensure that the solar panels are always operating at peak power and that the maximum power is delivered to the battery bank 811. The battery bank 811 consists of 24-individual high capacity 2-volt flooded-cell storage batteries that may use lead-acid or other rechargeable chemistries. At 50% state-of-charge, the battery bank 811 will provide over 27 KW-hr of energy storage. Further, a smart inverter 813 then converts the DC battery power from the battery bank 811 to 230-volt single-phase AC power required by a refrigeration system or other device. A backup generator 815 is capable of operating the electrical equipment 817 and charging the batteries; where refrigeration equipment 817 consumes approximately 6 KW when operating. If a duty cycle of 30% is assumed, this will lead to over 43 KW-hr of daily energy consumption. Those skilled in the art will recognize that the number of panels and batteries may vary depending on the overall size of the power supply system 800. A smart inverter 813 is used for detecting when the battery bank 811 has discharged to pre-set levels and automatically switches to the generator 815 as an alternate power source. Alternatively, the smart inverter 813 can switch to AC power mains on the grid. When batteries have recharged, the inverter automatically switches back to battery power from battery bank 811.

In use, on a typical day, with solar insolence at the design point, the solar panel array 801,803 will charge the battery bank 811 and operate electrical equipment 817 such as refrigeration equipment during daylight hours. After sunset, when the solar array 801, 803 is not providing power, the electrical equipment can operate totally from battery storage until sunrise at which point the solar array will recharge the batteries and operate the electrical equipment. For example, with refrigeration equipment, the battery bank 811 will fully support refrigeration for approximately 15 hours. However, this is a conservative estimate since during night operation and rainy-day operation, the thermal load is expected to decrease. During times of normal solar days and design point refrigeration operation the system will be 100% solar powered. If sufficient solar energy is not available and the battery bank voltage drops below the 50% state-of-charge set point the back-up generator will start. The generator start is controlled by the smart inverter. The generator will operate the refrigeration equipment and simultaneously recharge the batteries. When the battery bank has reached 100% state-of-charge the inverter control system will shut down the generator and the system will return to battery operation. An important feature of this design is during times of generator operation the current path is both to the load and to recharge batteries. This allows the generator to operate at the maximum efficiency point and will minimize fuel consumption and generator operating time. It also prevents “short-cycling” the generator. Any data logging can be accomplished through the inverter. This will assist to control refinements in algorithm operation dependent on the installation site.

FIG. 9 is a diagram illustrating a top view of a space efficient orientation of individual cells in the battery bank. The battery bank 900 includes a group of 24 batteries each having a 2-volt charge. Each battery includes a group of cells to achieve the 2 volts. When properly connected in series, these cells form a space efficient 48-volt non-symmetrical cube. In order to be space efficient, each of the cells is uniquely positioned in a predetermined orientation to achieve such a space efficient form factor. As seen in FIG. 9, the batteries are oriented in an X-axis and Y-axis to form a series of six columns. There are two types of columns, one column includes 3 batteries that are each positioned longitudinally end-to end. A second column includes 5 batteries that are aligned in a line side-to-side. Since the overall length of 3 batteries oriented end-to-end have the same length as 5 batteries oriented in a line side-to-side this enables a non-symmetrical cube-like shape to be made by alternating these two types of columns.

Thus, the battery bank shown in FIG. 9 has six columns. The first column is comprised of batteries 901, 903 and 905 and is of the first type of column. While the second column is of the second type comprised of batteries 907, 909, 911, 913, 915. The composition and batteries orientation are from the first and second columns are repeated three times. Thus, the third column is of the first type comprised of batteries 917, 919, 921 and the third column is of the second type comprised of batteries 923, 925, 927, 929 and 931. Similarly, the fifth column is of the first type and is comprised of batteries 933, 935, 937 and the sixth column is of the second type and is comprised of batteries 939, 941, 943, 945 and 947. Those skilled in the art will recognize that although the polarity of the batteries are arranged in a series manner to achieve 48 volts, the arrangement of the batteries in the first type column different from that the of the second type column. More specifically, the batteries in the first type column all have the same polarity on one side of the battery (e.g. the first column batteries 901, 903, 905 have their positive (+) polarity to the right as shown in FIG. 2, while in the second column the battery polarity alternates from right to left. For example, the battery 907 has the positive (+) polarity at one side (right) of the battery while battery 909 has the negative (−) polarity to the opposite side (left). The five batteries 907, 909, 911, 913 and 915 are alternated in this manner. When the batteries in columns 1 to 6 are configured in this way, the batteries can be more easily series connected allowing the battery bank 200 to achieve a compact, space efficient cube like shape.

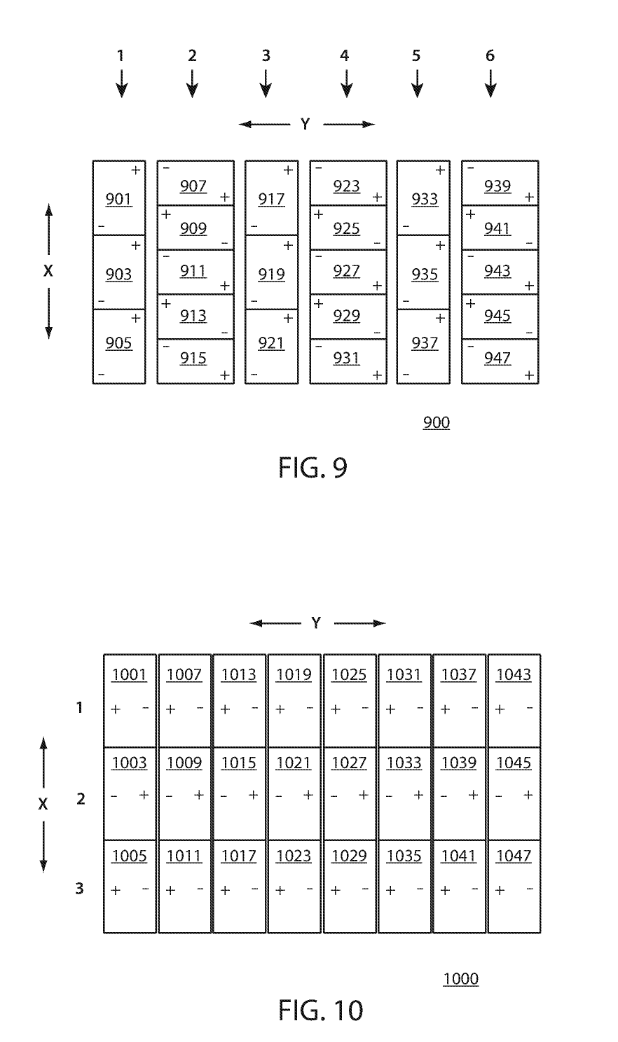

FIG. 10 is an alternative embodiment illustrating another space efficient orientation of cells in a battery bank. The battery bank 1000 includes a matrix of 24 batteries each having a 2-volt charge with terminal positioned on top of the battery. Each battery includes a group of cells to achieve the 2 volts. When properly connected in series, these cells form a space efficient 48-volt non-symmetrical cube shape. In order to be space efficient, each of the cells is uniquely positioned in a predetermined orientation to achieve a space efficient form factor. As seen in FIG. 10, the batteries are oriented in an X-axis and Y-axis to form a series of eight columns and three rows. In. the first and third rows, the batteries are all oriented left to right in a positive negative (+−) manner while in the second column the batteries are oriented left to right in a negative positive (−+) i.e. the opposite manner. Thus, the battery bank 1000, row 1 is comprised of batteries 1001, 1007, 1015, 1021, 1027, 1033, 1039 and 1045. Row 2 is comprised of batteries 1003, 1009, 1017, 1023, 1029, 1035, 1041 and 1047. Finally, row 2 is comprised of batteries 1005, 1011, 1019, 1025, 1031, 1037, 1043, 1049. When the batteries in row 1 to 2 are configured in this way, the batteries can also be easily series connected allowing the battery bank 1000 to achieve a compact, space efficient 24v cube like shape.

Thus, an embodiment of the present invention is directed to a solar powered charging system using a space efficient battery bank where batteries in the battery bank are ordered or configured into two types of columns that vary in the number of batteries and the orientation of the batteries with regard to their polarity. More specially, a 48v battery band is created using 24 cells. In a first type column, three batteries are used while in a second type column five batteries are used. In the first type column, the batteries are each oriented end to end so that one polarity e.g. (positive +) is to one side of the batteries. In the second type column, the batteries are oriented side-to-side and alternate polarity e.g. positive +, negative −, positive +, negative −, positive +. Three pairs or the first and second columns are then joined into a space efficient cube like structure.

An embodiment of the present invention is directed to an automatic generator starting (AGS) system that comprises at least one battery and a controller for monitoring a voltage. A relay system is used that is comprised of a plurality of relays that are individually actuated by the controller. A gasoline powered electric generator provides electrical power and the controller monitors the voltage of the at least one battery and the controller actuates the relay system for starting, running or stopping the gasoline powered generator when the voltage is at a predetermined value. The AGS system operates so the gasoline powered generator includes an ignition system that interfaces with the relay system and the ignition system includes an electric starter. In another embodiment, the AGS system is used for controlling starting, running and stopping the engine on a portable generator and comprises a controller for providing a plurality of voltages, a relay system having a plurality of relays and a battery monitor circuit. The controller, based on the battery monitor circuit, provides control voltages to the relay system for controlling operation of an ignition system in a gasoline powered generator. The relay system includes a least six relays, and operates an electric starter associated with the portable generator. A circuit breaker operates to turn off the generator in the event it produces an over voltage. The AGS system uses the controller to operate a solenoid that operates a choke in a carburetor of the portable generator. Further, a method for operating an automatic generator starting (AGS) system for a gasoline powered portable generator comprising the steps of: utilizing a controller for monitoring a voltage of at least one battery, individually operating a plurality of relays in a relay system by generating control voltages by the controller; and actuating the relay system by the controller when the voltage of the at least battery reaches above or below a predetermined value for starting, running or stopping the at least one gasoline powered portable generator. The method further includes the steps of interfacing the relay system with an ignition system associated with the portable generator and operating an electric starter associated with the ignition system using the relay system.

In another embodiment of the invention an atmospheric water generation system comprises an atmospheric water generator (AWG); a holding tank having a first ultraviolet (UV) light for disinfecting water in the holding tank; a pump for transporting the water from the holding tank to a multi-stage water filter wherein such water filter comprises in-seriatim: at least one sediment filter; at least one carbon block filter; at least one granular activated carbon filter; at least one second UV light; and at least one re-mineralization filter. The sediment filters sediment are over 5 microns in size and the at least one carbon block filter is comprised of two in-series carbon block filters for improving taste and removing odor. The first UV light and the at least one second UV light are solid state devices for conserving energy and the atmospheric water generation system is solar powered. In another embodiment of the invention, a solar powered atmospheric water generation system comprises an atmospheric water generator (AWG) utilizing an evaporator coil to produce water from the air; a holding tank positioned below the evaporator coil to collect the water; a first UV light positioned within the holding tank to kill bacteria and protozoa in the water. A multistage filtration system works for receiving water from the holding tank and cleaning the water of particulate matter, where the multi-stage filtration system includes a plurality of filters configured in-series and a second UV light positioned downstream of the plurality of filters for cleansing the water before consumption. The plurality of filters includes at least one sediment filter, a plurality of carbon block filters and a granular activated carbon filter. A re-mineralization filter is configured after the second UV filter for adding minerals to the water to enhance taste. In yet another embodiment, a method for forming an atmospheric water generation system comprises the steps of providing an atmospheric water generator (AWG); configuring a holding tank having a first ultraviolet (UV) light for disinfecting water in the holding tank and utilizing a pump for transporting the water from the holding tank to a multi-stage water filter wherein such water filter is configured in-seriatim; a sediment filter; at least one carbon block filter; a granular activated carbon filter; a second UV light; and a re-mineralization filter. The method further includes the steps of configuring the sediment filters such that it filters particulates over 5 microns in size; configuring the at least one carbon block filter such that it is comprised of a first carbon block filter and a second carbon block filter for improving taste and removing odor; configuring the first UV light and second UV light such that they are light emitting diodes (LEDs) for conserving energy and configuring the water generation system so that it is solar powered.

In other embodiments of the invention, a method for repurposing a shipping container into a refrigerated cold box comprising the steps of: cleaning the inside and outside of the shipping container; framing the interior of the shipping container with at least one predetermined compartment; applying insulation with a specific R-Value within the interior of the at least one predetermined compartment to a predetermined depth; installing walls and flooring with plywood covered in stainless steel sheet; and painting the exterior of the shipping container with thermal protective coating. The method further includes the steps of sanding and/or priming the inside and outside of the shipping container; installing a c-channel around at least one door of the shipping container; filling the c-channel with foam insulation for improving insulation around the at least one door and/or wrapping the outside of the shipping container with a corrugated metal skin. In other embodiments a method for converting a shipping container into a refrigerated cold box is taught that comprising the steps of: cleaning the inside and outside of the shipping container with pressurized water; applying priming paint to the inside surface and outside surface of the shipping container; constructing framing inside the shipping container to form at least one compartment; installing a c-channel around at least one door accessing the shipping container; applying foam insulation inside the at least one compartment and the c-channel; installing plywood covered with stainless steel sheet to the walls and floor of the at least one compartment; and painting the outside of the shipping container with thermal protective coating for increasing the R factor of the insulation. The method further includes the steps of: sanding rust from inside and outside surfaces of the shipping container and installing a corrugated metal skin on the outer surface of shipping container. In still yet another embodiment, a method for repurposing a shipping container into a refrigerated cold box comprising the steps of: cleaning the inside and outside of the shipping container; priming the inside and outside of the shipping container; framing the interior of the shipping container into at least one predetermined compartment; spraying foam insulation within the interior of the at least one predetermined compartment to a predetermined R value; installing a c-channel around at least one door of the shipping container; filling the c-channel with foam insulation for improving insulation around the at least one door installing walls and flooring with building materials covered in stainless steel sheeting; painting any interior surfaces not covered in stainless steel sheeting; and painting the exterior of the shipping container with thermal protective coating to provide a insulative layer to the at least one interior compartment. The method further includes the steps of: sanding inside and outside of the shipping container to remove rust; and wrapping the outer surface of the shipping container with a corrugated metal skin.

In still yet another embodiment of the invention, a solar powered charging system using a space efficient battery bank comprising: at least one solar panel; at least once charge controller for controlling a charge voltage provided by the at least one solar panel; a battery bank configured using a plurality of batteries for storing electric energy provided from the at least one charge controller; and wherein the batteries in the battery bank are arranged into a plurality of columns wherein a first type of column includes three batteries arranged end-to-end and a second type of column includes five batteries arranged side-to-side such that a compact bank is formed by alternating a first type column and second type column into a group of six columns. The batteries used in the first type column are oriented so that their polarity is on the same side as one another and the batteries used on the second type column are oriented so that their polarity alternates from the polarity of the adjacent battery. The battery bank forms a non-symmetrical cube-like shape and includes at least 24 batteries. In another embodiment, a solar powered charging system using a space efficient battery bank comprising: at least one solar panel; at least once charge controller for controlling a charge voltage provided by the at least one solar panel; a battery bank configured using a plurality of batteries for storing electric energy provided from the at least one charge controller; an inverter for converting DC power from the battery bank to AC power; and wherein the batteries in the battery bank are arranged into a group of six columns with each column being of a first type or second type such that a first type of column includes three batteries arranged end-to-end and configured so their polarity is on the same side of the battery and a second type of column includes five batteries arranged side-to-side and configured so that their polarity alternates from the polarity of each adjacent battery such that a non-symmetrical cube-like shape is formed by alternating a first type column and second type column. The battery bank includes 24 batteries. Finally, in another embodiment of the invention, a method for utilizing a space efficient battery bank in a solar powered charging system comprising the steps of: providing at least one solar panel; providing at least once charge controller for controlling a charge voltage provided by the at least one solar panel; configuring a battery bank using a plurality of batteries for storing electric energy provided from the at least one charge controller; and arranging the batteries in the battery bank into a plurality of columns wherein a first type of column includes three batteries arranged end-to-end and a second type of column includes five batteries arranged side-to-side such that a compact bank is formed by alternating a first type column and second type column into a group of six columns. The method further includes the steps of orienting each of the batteries used in the first type column so their positive or negative polarity is on the same side of each battery; orienting each of the batteries used on the second type column are oriented so that their polarity alternates from the polarity of each adjacent battery; forming the plurality of batteries in the plurality of columns into a non-symmetrical cube-like shape; utilizing 24 batteries in the battery bank; and/or configuring the batteries in the battery bank to achieve 48 volts total voltage.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. An automatic generator starting (AGS) system comprising:
at least one battery;
a controller for monitoring a voltage;
a relay system comprised of a plurality of relays that are individually actuated by the controller;
a gasoline powered generator; and
wherein the controller monitors the voltage of the at least one battery and the controller actuates the relay system for starting, running or stopping the gasoline powered generator when the voltage is at a predetermined value.

2. An AGS system as in claim 1, wherein the gasoline powered generator includes an ignition system that interfaces with the relay system.

3. An AGS system as in claim 2, wherein the ignition system includes an electric starter.

4. An automatic generator start (AGS) system for controlling starting, running and stopping the engine on a portable generator comprising:
a controller for providing a plurality of voltages;
a relay system having a plurality of relays;
a battery monitor circuit; and
wherein the controller determines based on the battery monitor circuit to provide control voltages to the relay system for controlling operation of an ignition system in a gasoline powered generator.

5. An AGS system as in claim 4, wherein the relay system operates an electric starter associated with the portable generator.

6. An AGS system as in claim 4, further comprising a circuit breaker operating to turn off the generator in the event it produces an over voltage.

7. An AGS system as in claim 4, wherein the relay system includes at least six (6) relays.

8. An AGS system as in claim 4, wherein the controller operates to control a solenoid that operates a choke in a carburetor of the portable generator.

9. A method for operating an automatic generator starting (AGS) system for a gasoline powered portable generator comprising the steps of:
utilizing a controller for monitoring a voltage of at least one battery;
individually operating a plurality of relays in a relay system by generating control voltages by the controller;
actuating the relay system by the controller when the voltage of the at least battery reaches above or below a predetermined value for starting, running or stopping the at least one gasoline powered portable generator.

10. A method for operating an AGS system as in claim 9, further comprising the step of:
interfacing the relay system with an ignition system associated with the portable generator.

11. A method for operating AGS system as in claim 10, further comprising the step of:
operating an electric starter associated with the ignition system using the relay system.

12. An atmospheric water generation system comprising:
an atmospheric water generator (AWG);
a holding tank having a first ultraviolet (UV) light for disinfecting water in the holding tank;
a pump for transporting the water from the holding tank to a multi-stage water filter wherein such water filter comprises in-seriatim:
at least one sediment filter;
at least one carbon block filter;
at least one granular activated carbon filter;
at least one second UV light; and
at least one re-mineralization filter.

13. An atmospheric water generation system as in claim 12, wherein sediment filters sediment over 5 microns in size.

14. An atmospheric water generation system as in claim 12, wherein the at least one carbon block filter is comprised of two in-series carbon block filters for improving taste and removing odor.

15. An atmospheric water generation system as in claim 12, wherein the first UV light and the at least one second UV light are solid state devices for conserving energy.

16. An atmospheric water generation system as in claim 12, wherein the atmospheric water generation system is solar powered.

17. A solar powered atmospheric water generation system comprising:
an atmospheric water generator (AWG) utilizing an evaporator coil to produce water from the air;
a holding tank positioned below the evaporator coil to collect the water;
a first UV light positioned within the holding tank to kill bacteria and protozoa in the water;
a multistage filtration system for receiving water from the holding tank and cleaning the water of particulate matter, where the multi-stage filtration system includes a plurality of filters configured in-series and a second UV light positioned downstream of the plurality of filters for cleansing the water before consumption.

18. A solar powered atmospheric water generation system as in claim 17, wherein plurality of filters include at least one sediment filter, a plurality of carbon block filters and a granular activated carbon filter.

19. A solar powered atmospheric water generation system as in claim 18, further comprising a re-mineralization filter configured after the second UV filter for adding minerals to the water to enhance taste.

20. A method for forming an atmospheric water generation system comprising the step of:
providing an atmospheric water generator (AWG);
configuring a holding tank having a first ultraviolet (UV) light for disinfecting water in the holding tank;
utilizing a pump for transporting the water from the holding tank to a multi-stage water filter wherein such water filter is configured in-seriatim; a sediment filter; at least one carbon block filter; a granular activated carbon filter; a second UV light; and a re-mineralization filter.

21. An atmospheric water generation system as in claim 20, further comprising the step of:
configuring the sediment filters such that it filters particulates over 5 microns in size.

22. An atmospheric water generation system as in claim 21, further comprising the step of:
configuring the at least one carbon block filter such that it is comprised of a first carbon block filter and a second carbon block filter for improving taste and removing odor.

23. An atmospheric water generation system as in claim 20, further comprising the step of:
configuring the first UV light and second UV light such that they are light emitting diodes (LEDs) for conserving energy.

24. An atmospheric water generation system as in claim 20, further comprising the step of:
configuring the water generation system so that it is solar powered.

25. A method for repurposing a shipping container into a refrigerated cold box comprising the steps of:
cleaning the inside and outside of the shipping container;
framing the interior of the shipping container with at least one predetermined compartment;
applying insulation with a specific R-Value within the interior of the at least one predetermined compartment to a predetermined depth;
installing walls and flooring with plywood covered in stainless steel sheet; and
painting the exterior of the shipping container with thermal protective coating.

26. A method for repurposing a shipping container as in claim 25, further comprising the step of:
sanding and priming the inside and outside of the shipping container;

27. A method for repurposing a shipping container as in claim 25, further comprising the steps of:
installing a c-channel around at least one door of the shipping container;
filling the c-channel with foam insulation for improving insulation around the at least one door.

28. A method for repurposing a shipping container as in claim 25, further comprising the step of:
wrapping the outside of the shipping container with a corrugated metal skin.

28. A method for converting a shipping container into a refrigerated cold box comprising the steps of:
cleaning the inside and outside of the shipping container with pressurized water;
applying priming paint to the inside surface and outside surface of the shipping container;
constructing framing inside the shipping container to form at least one compartment;
installing a c-channel around at least one door accessing the shipping container;
applying foam insulation inside the at least one compartment and the c-channel;
installing plywood covered with stainless steel sheet to the walls and floor of the at least one compartment; and
painting the outside of the shipping container with thermal protective coating for increasing the R factor of the insulation.

29. A method for converting a shipping container as in claim 28, further comprising the step of:
sanding rust from inside and outside surfaces of the shipping container;

30. A method for converting a shipping container as in claim 28, further comprising the step of:
installing a corrugated metal skin on the outer surface of shipping container.

31. A method for repurposing a shipping container into a refrigerated cold box comprising the steps of:
cleaning the inside and outside of the shipping container;
priming the inside and outside of the shipping container;
framing the interior of the shipping container into at least one predetermined compartment;
spraying foam insulation within the interior of the at least one predetermined compartment to a predetermined R value;
installing a c-channel around at least one door of the shipping container;
filling the c-channel with foam insulation for improving insulation around the at least one door installing walls and flooring with building materials covered in stainless steel sheeting;
painting any interior surfaces not covered in stainless steel sheeting; and
painting the exterior of the shipping container with thermal protective coating to provide a insulative layer to the at least one interior compartment.

32. A method for repurposing a shipping container as in claim 31, further comprising the step of:
sanding inside and outside of the shipping container to remove rust.

33. A method for repurposing a shipping container as in claim 31, further comprising the step of:
wrapping the outer surface of the shipping container with a corrugated metal skin.

34. A solar powered charging system using a space efficient battery bank comprising:
at least one solar panel;
at least once charge controller for controlling a charge voltage provided by the at least one solar panel;
a battery bank configured using a plurality of batteries for storing electric energy provided from the at least one charge controller; and
wherein the batteries in the battery bank are arranged into a plurality of columns wherein a first type of column includes three batteries arranged end-to-end and a second type of column includes five batteries arranged side-to-side such that a compact bank is formed by alternating a first type column and second type column into a group of six columns.

35. A solar powered charging system as in claim 34, wherein each of the batteries used in the first type column are oriented so that their polarity is on the same side as one another.

36. A solar powered charging system as in claim 34, wherein each of the batteries used on the second type column are oriented so that their polarity alternates from the polarity of the adjacent battery.

37. A solar powered charging system as in claim 34, wherein the battery bank forms a non-symmetrical cube-like shape.

38. A solar powered charging system as in claim 34, wherein the battery bank includes 24 batteries.

39. A solar powered charging system using a space efficient battery bank comprising:
at least one solar panel;
at least once charge controller for controlling a charge voltage provided by the at least one solar panel;
a battery bank configured using a plurality of batteries for storing electric energy provided from the at least one charge controller;
an inverter for converting DC power from the battery bank to AC power; and
wherein the batteries in the battery bank are arranged into a group of six columns with each column being of a first type or second type such that a first type of column includes three batteries arranged end-to-end and configured so their polarity is on the same side of the battery and a second type of column includes five batteries arranged side-to-side and configured so that their polarity alternates from the polarity of each adjacent battery such that a non-symmetrical cube-like shape is formed by alternating a first type column and second type column.

40. A solar powered charging system as in claim 39, wherein the battery bank includes 24 batteries.

41. A method for utilizing a space efficient battery bank in a solar powered charging system comprising:
providing at least one solar panel;
providing at least once charge controller for controlling a charge voltage provided by the at least one solar panel;
configuring a battery bank using a plurality of batteries for storing electric energy provided from the at least one charge controller; and
arranging the batteries in the battery bank into a plurality of columns wherein a first type of column includes three batteries arranged end-to-end and a second type of column includes five batteries arranged side-to-side such that a compact bank is formed by alternating a first type column and second type column into a group of six columns.

42. A method for utilizing a space efficient battery bank as in claim 41, further comprising the step of:
orienting each of the batteries used in the first type column so their positive or negative polarity is on the same side of each battery.

43. A method for utilizing a space efficient battery bank as in claim 41, further comprising the step of:
orienting each of the batteries used on the second type column are oriented so that their polarity alternates from the polarity of each adjacent battery.

44. A method for utilizing a space efficient battery bank as in claim 41, further comprising the step of:
forming the plurality of batteries in the plurality of columns into a non-symmetrical cube-like shape.

45. A method for utilizing a space efficient battery bank as in claim 41, further comprising the step of:
utilizing 24 batteries in the battery bank.

46. A method of utilizing a space efficient battery bank as in claim 41, further comprising the step of;
configuring the batteries in the battery bank to achieve 48 volts total voltage.
